(19) United States
(12) Patent Application Publication
(10) Pub. No.: US 2002/0149452 A1
(43) Pub. Date: Oct. 17, 2002

(54) Low-voltage switching device

(75) Inventors: Guenther Baujan, Troisdorf (DE); Rudolf Baumeister, Hennef (DE); Volker Blechacz, Bornheim (DE); Manfred Faust, St. Augustin (DE); Klaus Dauer, Koblenz (DE); Lothar Winzen, Unkel (DE); Peter Willerscheidt, Remagen (DE)

Correspondence Address: DAVIDSON, DAVIDSON & KAPPEL, LLC, 485 SEVENTH AVENUE, 14TH FLOOR, NEW YORK, NY, 10018, US

(73) Assignee: MOELLER GmbH, Bonn (DE)

(21) Appl. No.: 10/096,547

(22) Filed: Mar. 13, 2002

Related U.S. Application Data
(63) Continuation of application No. PCT/EP00/08337, filed on Aug. 26, 2000.

(30) Foreign Application Priority Data
Sep. 14, 1999 (DE) DE 199 43 965.6

(51) Int. Cl. H01H 67/02

(52) U.S. Cl. 335/132

(57) ABSTRACT

A low-voltage switching device includes a guide insert for receiving the bridge contact of the device. The guide insert can be fixed without play inside the housing of the switching device. The bridge contact is mounted in the guide insert in a manner that permits it to linearly move counter to a spring force.

This is a continuation of International Application No. PCT/EP00/08337, with an international filing date of Aug. 26, 2000.

### BACKGROUND

The present invention relates to a low-voltage switching device having a housing, a double-break bridge contact, two arcing chambers allocated to contact separation points, a plunger for actuating the bridge contact, and a drive unit.

A switching device of this type is described in European Patent Document No. EP 0 647 350 B1. This switching device has a housing in which a double-break bridge contact is arranged for each pole. In this context, the contact bridge is supported in an actuating plunger in known manner. The actuating plunger, in turn, is supported in a cage, the cage having slotted-hole shaped windows for the passage of the linearly movable contact bridge. Furthermore, the cage features lateral insulating wings for bounding the arcing chamber. This system can be preassembled and fixedly arranged in the housing of the switching device.

In prior devices, in which the bridge contact is movably supported in an actuating plunger and the actuating plunger is supported in a linearly movable manner in the switch housing itself or in a cage which can be inserted into the housing of the switching device, at least two guide plays are present (bridge contact/plunger and plunger/housing or bridge contact/plunger and plunger/cage).

### SUMMARY OF THE INVENTION

An object of the present invention is to provide a low-voltage switching device in which the guide play of the bridge contact is markedly reduced and thus the guidance of bridge contact is more precise.

The present invention provides a low-voltage switching device. The device includes: a housing having an upper housing part and a lower housing part; a double-break bridge contact; a pair of arcing chambers associated contact separation points of the bridge contact; a plunger configured for actuating the bridge contact; a drive unit; and a guide insert configured for receiving the bridge contact. The bridge contact is supported in the guide insert so as to be linearly movable against a spring force. The guide insert is capable of being fixed without play in the housing.

The guide play of the bridge contact is minimized by designing a separate guide insert according to the present invention which is supported without play in the housing of the switching device, preferably being pressed in, and in which the bridge contact is supported in such a manner that it is linearly movable against a spring force, it being possible to actuate the bridge contact via a separate plunger. In this manner, it is achieved that a guide play occurs just between the guide insert and the bridge contact supported therein. Via the guidance, according to the present invention, of the bridge contact in the guide unit, which can be fixed without play in the housing, the bridge contact guidance is markedly improved. Unlike the related art, where the bridge contact is guided in the actuating plunger, the present invention eliminates the play which otherwise occurs between plunger and bridge contact. Due to the more precise bridge contact guidance, it is possible to build a switching device in which the bridge contact can be placed closer to the arcing chamber without having to fear a welding of the bridge contact to the arc splitter plates. Because of this, an electric arc occurring, in particular in the case of short circuits, is guided into the arcing chamber earlier so that the quenching performance of a switching device designed in this manner is improved.

### BRIEF DESCRIPTION OF THE DRAWINGS

Further details and advantages of the present invention will be explained based on an exemplary embodiment with reference to the drawings.

FIG. 1 is an exploded view of a lower part of a switching device according to the present invention;

FIG. 2 depicts a possible embodiment of the guide insert according to the present invention with spring and bridge contact; and

FIG. 3 shows the lower part of the switching device according to FIG. 1 in the assembled condition.

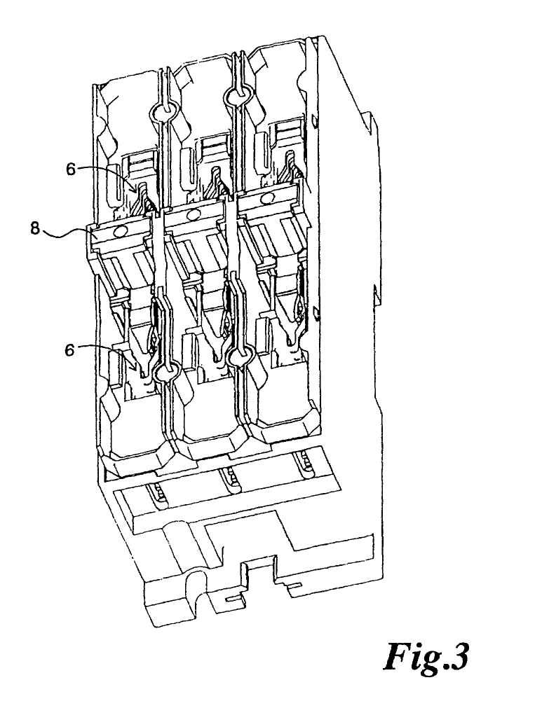

### DETAILED DESCRIPTION

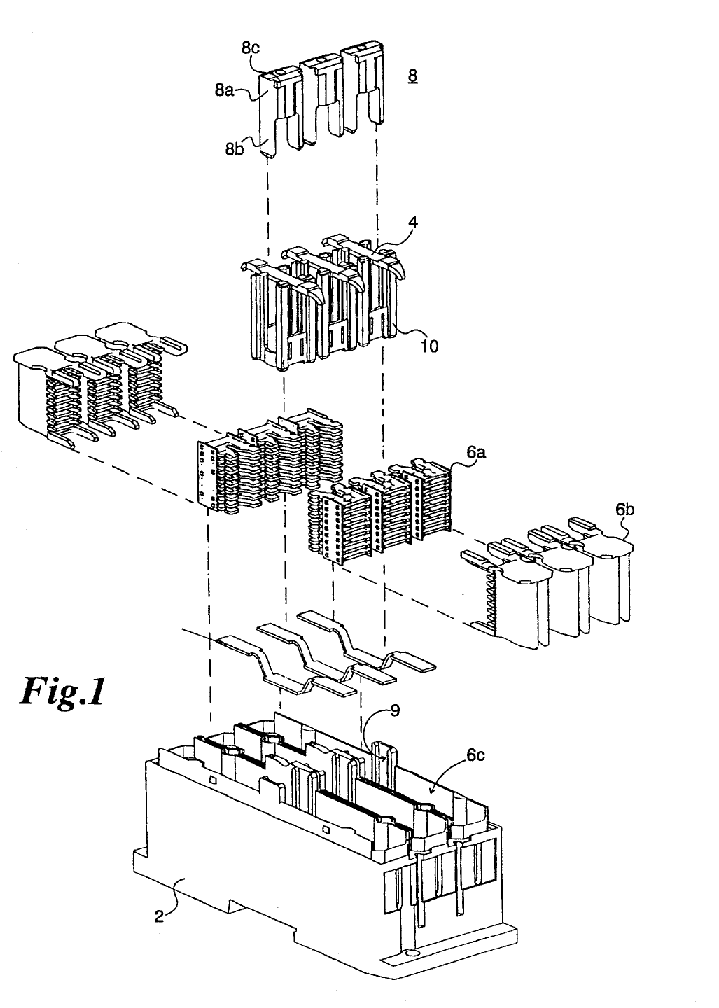

FIG. 1 depicts an exploded view of components of the switching device according to the present invention. The switching device includes a housing featuring a lower housing part 2 and an upper housing part as well as a double-break bridge contact 4 for each pole, and two stationary contacts interacting with bridge contact 4, two arcing chambers 6 allocated to the contact points of each bridge contact, in each case one plunger 8 for actuating a bridge contact 4, and a drive unit for acting upon plunger 8 or bridge contact 4, it being preferred for the drive unit to be operable at least electromagnetically.

Each arcing chamber 6 includes at least one arc splitter plate stack 6a and a holding device 6b for accommodating arc splitter plate stack 6a. To form an arcing chamber 6, a unit including an arc splitter plate stack 6a and a holding device 6b is then inserted into an opening 6c of lower housing part 2 provided for this.

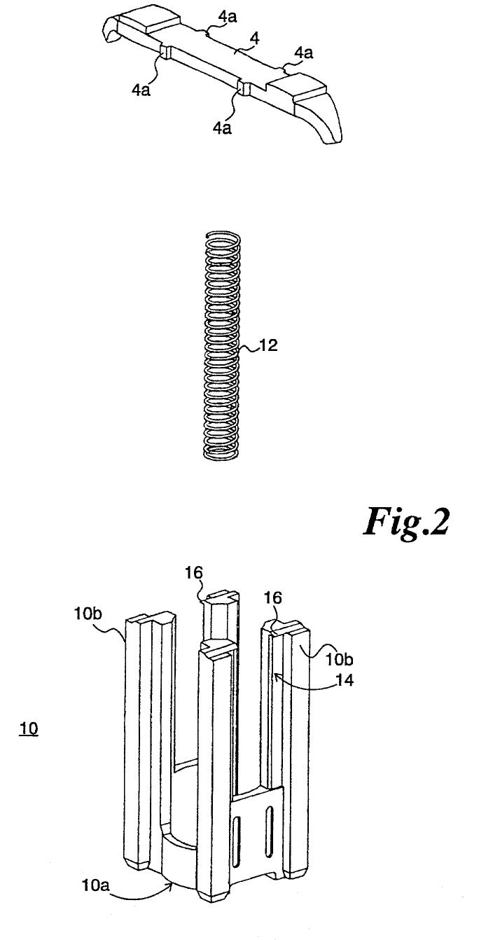

Also shown is a preassembled unit including a guide insert 10, a spring element 12 (see FIG. 2) and bridge contact 4 which is supported inside guide insert 10 in a manner that it is linearly movable against a spring force. This preassembled unit can be fixed without play in lower housing part 2, preferably by a force fit. In this connection, the force fit is achieved by an exact, mutually matched dimensional accuracy of guide insert 10 and of the receptacle provided for the guide insert in the housing of the switching device. The force fit can, of course, also be achieved by tapering the interacting surfaces of guide insert 10 and the housing receptacle for the guide insert.

A preferred embodiment of guide insert 10 is shown in FIG. 2. In this connection, guide insert 10 is preferably designed as a one-piece, injection-molded part composed of insulating material. Guide insert 10 is substantially composed of a plate-like (or ring-shaped or the like) base part 10a from where preferably four guide columns 10b extend perpendicularly. In this connection, guide columns 10b are arranged, in particular, in such a manner that two neighboring guide columns 10b lie in one plane, respectively, and the planes run parallel to each other. It is preferred for the columns to form the corners of a square as viewed from above. Guide insert 10 can be preassembled with a spring element 12 and bridge contact 4 to from a unit. To this end, guide insert 10 is advantageously open from one of its end faces so that spring element 12, here a spiral spring, can be inserted from one end face in a simple manner. Moreover, bridge contact 4 can also be inserted from above so that it is supported in a linearly movable manner between two pairs of guide columns. To simplify the assembly and to be able to preassemble the individual components in the form of a unit, it is required for bridge contact 4, which is biased by spring element 12, to be retained in guide unit 10. To this end, bridge contact 4 preferably has two projecting guide lugs 4a at each of its long sides. Guide insert 10, in turn, preferably features guide shoulders 14 which extend along guide columns 10b and which are limited at the free ends of guide columns 10b by stop extensions 16 which are directed outward.

Thus, for assembling this unit, spring element 12 is to be inserted into guide insert 10 and, subsequently, bridge contact 4 has to be slightly rotated about its longitudinal axis so that it can be introduced between guide columns 10b against the spring force and there be rotated into its original position again in such a way it makes contact against guide shoulders 14 with its guide lugs 4a and is pushed by spring element 12 in the direction of the free guide column ends and is retained there in guide insert 10 by limiting extensions 16.

Moreover, the edges of guide columns 10b facing the interior of the guide insert are preferably beveled so that plunger 8, in adaptation thereto, is reliably guided between guide columns 10b with its plunger body 8a for actuating bridge contact 4. To improve the plunger guidance, plunger 8 has elongated guide flanks 8b at opposite sides of its essentially cuboidal plunger body 8a. To accommodate guide flanks 8b of plunger 8, lower housing part 2 has corresponding recesses 9.

In order for plunger 8 to be limited in its actuator travel, it has at least one extension 8c at the top end which cooperates with at least one end face of a free end of a guide column 10b.

The present invention is not limited to the specific embodiments described above but is intended to be defined in scope by the appended claims. Thus, guide insert 10 can also be designed, for example, in the form of a closed cuboidal block which then has suitable clearance windows for receiving bridge contact 4, which is supported in a linearly movable manner, and for receiving spring element 12. Then, it would be possible for bridge contact 4 to be actuated via a plunger which acts upon bridge contact 4 via an opening at the end face of the block or which acts immediately thereon via the bridge contact ends laterally projecting from the clearance window. Moreover, all features shown in the drawing belong to the present invention. In particular, the geometric designs as shown.

What is claimed is:

1. A low-voltage switching device comprising:
a housing having an upper housing part and a lower housing part:
a double-break bridge contact;
a pair of arcing chambers associated contact separation points of the bridge contact;
a plunger configured for actuating the bridge contact;
a drive unit; and
a guide insert configured for receiving the bridge contact, the bridge contact being supported in the guide insert so as to be linearly movable against a spring force, the guide insert being capable of being fixed without play in the housing.

2. The switching device as recited in claim 1 wherein the guide insert is a one-piece injection-molded part.

3. The switching device as recited in claim 2 wherein the guide insert includes an insulating material.

4. The switching device as recited in claim 1 wherein the guide insert includes a base part and at least four guide columns, the guide columns extending perpendicularly from the base part parallel to each other.

5. The switching device as recited in claim 1 wherein the guide insert includes at least four guide columns disposed parallel to each other and a spring element disposed between the guide columns.

6. The switching device as recited in claim 5 wherein the spring element includes a spiral spring.

7. The switching device as recited in claim 5 wherein each of the guide columns include a stop extension at a respective free end thereof, the stop extension extending outward and configured for retaining the bridge contact, the bridge contact being biased by the spring force.

8. The switching device as recited in claim 1 wherein the guide insert includes at least four guide columns disposed parallel to each other, a respective edge of each of the guide columns facing an interior of the guide insert including a beveled surface, and wherein the plunger includes sliding surfaces adapted for cooperating with the beveled surfaces of the guide insert so as to be guided inside the guide insert.

9. The switching device as recited in claim 1 wherein the plunger includes at least one extension at a top end thereof configured for cooperating with at least one end face of free ends of the guide columns so as to limit a switching travel of the switching device.
